(19) United States
(12) Patent Application Publication
(10) Pub. No.: US 2022/0415003 A1
(43) Pub. Date: Dec. 29, 2022

(54) VIDEO PROCESSING METHOD AND ASSOCIATED SYSTEM ON CHIP

(71) Applicant: Realtek Semiconductor Corp., Hsinchu (TW)

(72) Inventors: Ching-Lung Chen, HsinChu (TW); Chia-Chun Cheng, HsinChu (TW)

(73) Assignee: Realtek Semiconductor Corp., HsinChu (TW)

(21) Appl. No.: 17/750,427

(22) Filed: May 23, 2022

Related U.S. Application Data
(60) Provisional application No. 63/215,515, filed on Jun. 27, 2021.

(30) Foreign Application Priority Data
Oct. 14, 2021 (TW) 110138102

(51) Int. Cl. G06V 10/22; G06V 40/10; G10L 25/57; G06V 20/40

(52) U.S. Cl. CPC G06V 10/22; G06V 40/10; G10L 25/57; G06V 20/40

(57) ABSTRACT

The present invention provides a SoC including a person recognition circuit, a sound detection circuit and a processing circuit. The person recognition circuit is configured to obtain image data from an image capturing device, and perform a person recognition operation on the image data to generate a recognition result. The sound detection circuit is configured to receive a plurality of sound signals from a plurality of microphones, and determine a sound characteristic value of a main sound. The processing circuit is configured to determine a specific region in the image data according to the recognition result and the sound characteristic value of the main sound, and process the image data to highlight the specific region.

### CROSS REFERENCE TO RELATED APPLICATIONS

This application claims the benefit of U.S. Provisional Application No. 63/215,515, filed on Jun. 27, 2021. The content of the application is incorporated herein by reference.

### BACKGROUND OF THE INVENTION

### 1. Field of the Invention

The present invention relates to a video processing method for live streaming.

### 2. Description of the Prior Art

Live streaming is widely used in society, for example, it can be used in remote video conferences. However, when one party in the remote video conference includes multiple participants in the video, it may sometimes be difficult for the other party's participants to know who is speaking in the video. Specifically, it is assumed that a first party and a second party are currently engaged in the remote video conference, where the first party has multiple participants in a conference room, and the audio and video information of the conference room is captured through the microphone and camera, and the audio and video information is transmitted to the remote second party through the network; and due to the posture and position problems of the multiple participants of the first-party, the participants of the second party may not be able to see which one is speaking, causing confusion to the second party and affecting the efficiency of the conference.

### SUMMARY OF THE INVENTION

It is therefore an objective of the present invention to provide a person tracking technology applied to remote video, which can highlight the person who is currently speaking in the image, so as to solve the problems described in the prior art.

According to one embodiment of the present invention, a system on chip comprising a person recognition circuit, a sound detection circuit and a processing circuit is disclosed. The person recognition circuit is configured to obtain image data from an image capturing device, and perform a person recognition operation on the image data to generate a recognition result. The sound detection circuit is configured to receive a plurality of sound signals from a plurality of microphones, and determine a sound characteristic value of a main sound. The processing circuit is coupled to the person recognition circuit and the sound detection circuit, and is configured to determine a specific region in the image data according to the recognition result and the sound characteristic value of the main sound, and process the image data to highlight the specific region.

According to one embodiment of the present invention, a video processing method comprises the steps of: obtaining image data from an image capturing device, and performing a person recognition operation on the image data to generate a recognition result; receiving a plurality of sound signals from a plurality of microphones, to determine a sound characteristic value of a main sound; determining a specific region in the image data according to the recognition result and the sound characteristic value of the main sound; and processing the image data to highlight the specific region.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a remote video conference.

FIG. 2 is an electronic device according to one embodiment of the present invention.

FIG. 3 is a flowchart of a video processing method according to one embodiment of the present invention.

FIG. 4 is a schematic diagram of a plurality of persons in the image recognized by the person recognition circuit.

FIG. 5 is a diagram of highlighting the person speaking in the image.

### DETAILED DESCRIPTION

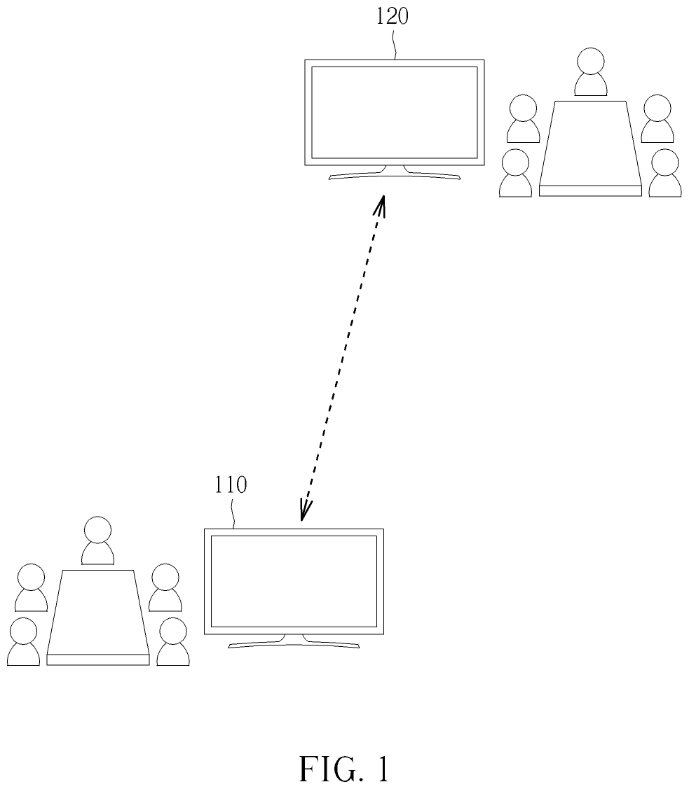

FIG. 1 is a diagram of a remote video conference. As shown in FIG. 1, there is an electronic device 110 in a first conference room for capturing images and recording the sound in the first conference room in real time, and the captured images and the recorded sounds are transmitted to a second conference room through the network, for an electronic device 120 in the second conference room to display the images and play the sound of the first conference room. Similarly, the electronic device 120 in the second conference room captures images and records the sound in the second conference room in real time, and the captured images and the recorded sounds are transmitted to the first conference room through the network, for the electronic device 110 in the first conference room to display the images and play the sound of the second conference room. In this embodiment, the electronic device 110 and the electronic device 120 can be any electronic device with image and audio transceiver functions and network communication functions, such as televisions, notebook, tablet, mobile phones, etc.

As described in the prior art, when one party in the remote video conference includes multiple participants in the video, it may sometimes be difficult for the other party's participants to know who is speaking in the video. For example, if the participant(s) in the second conference room is not familiar with the voice of the participant in the first conference room, or if the participant who is speaking in the first conference room is not facing the camera, or some image transmission factors, it may sometimes be difficult for the participant in the second conference room to know who is speaking through the audio and video played by the electronic device 120, causing confusion for the participant of the second conference room. Therefore, a system on chip (SoC) in the electronic device 110 of this embodiment provides a method that can highlight the participant who is speaking in the video, so that the participant in the second conference room can clearly know which participant is speaking in the first conference room, to solve the above problems.

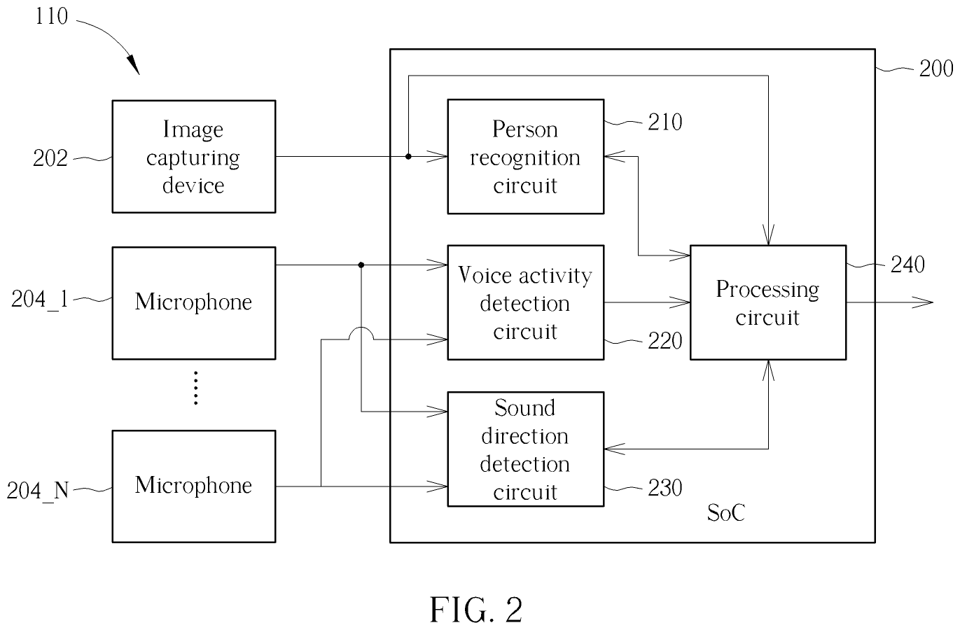

FIG. 2 is an electronic device according to one embodiment of the present invention. As shown in FIG. 2, the electronic device 110 comprises a SoC 200, an image capturing device 202 and a plurality of microphones 204_1-204_N, wherein N is any suitable positive integer greater than one. In addition, the SoC 200 includes a person recognition circuit 210, a voice activity detection circuit 220, a sound detection circuit (in this embodiment, a sound direction detection circuit 230 is used as an example), and a processing circuit 240. In this embodiment, the image capturing device 202 can be a camera or a video camera to continuously capture images in the first conference room in real time to generate image data to the SoC 200, wherein the image data received by the SoC 200 may be raw data or image data that has been processed. The microphones 204_1-204_N may be digital microphones, which are disposed at different positions of the electronic device 110 to respectively generate a plurality of sound signals to the SoC 200.

It is noted that, in the embodiment of FIG. 2, the image capturing device 202 and the microphones 204_1-204_N are positioned within the electronic device 110. In other embodiments, however, the image capturing device 202 and the microphones 204_1-204_N can be externally connected to the electronic device 110.

In the SoC 200, the person recognition circuit 210 is used to identify person in the image data received from the image capturing device 202, to determine whether there is a person in the received image data, and to determine the characteristic value of each person and the position/region of each person in the image. Specifically, the person recognition circuit 210 can use a deep learning or neural network module to process each frame in the image data, such as using multiple different convolution filters to perform convolution operations on the frame (image frame) to identify whether there is a person in the frame. In addition, for the detected persons, a characteristic value of each person (or, a characteristic value of the region where each person is located) is determined by a previously used deep learning or neural network module, where the characteristic value can be represented as a multidimensional vector, such as a vector with dimension ‘512’. It is noted that the above-mentioned circuit design related to person recognition is well known to a person skilled in the art, and one of the main features of this embodiment is the applications of the person identified by the person recognition circuit 210 and the characteristic value thereof, so other details of the person recognition circuit 210 are not described here.

The voice activity detection circuit 220 is used to receive the sound signals from the microphones 204_1-204_N, and to determine whether there are voice components in the sound signals. Specifically, the voice activity detection circuit 220 can mainly perform the following operations: perform noise reduction operation on the received sound signal, convert the sound signal into a frequency domain, and process blocks to obtain characteristic values; and the characteristic value of is compared with a reference value to determine whether the sound signal is a voice signal. It is noted that since the related circuit design of the voice activity detection circuit 220 is well known to a person skilled in the art, and one of the main features of this embodiment is to perform the follow-up operations according to the determination result of the voice activity detection circuit 220, so other details of the voice activity detection circuit 220 will not be described here. In another embodiment, the voice activity detection circuit 220 can only receive the sound signals from some of the microphones 204_1-204_N, and does not need to receive the sound signals from all the microphones 204_1-204_N.

Regarding the operation of the sound direction detection circuit 230, since the positions of the microphones 204_1-204_N on the electronic device 110 are known, the sound direction detection circuit 230 can determine an azimuth of the main sound in the first conference room according to a time difference of the sound signals from the microphones 204_1-204_N (that is, phase differences between the received sound signals). That is, the sound direction detection circuit 230 determines direction and angle of the main speaker relative to the electronic device 110. In this embodiment, the sound direction detection circuit 230 can only determine one direction, that is, if there are multiple people talking at the same time in the first conference room, it will be determined from which direction the main sound comes from according to some characteristics (e.g., signal strength) of the multiple received sound signals. It is noted that since the related circuit design of the sound direction detection circuit 230 is well known to a person skilled in the art, and one of the main features of this embodiment is to perform the follow-up operations according to the detection result of the sound direction detection circuit 230, so other details of the sound direction detection circuit 230 will not be described here.

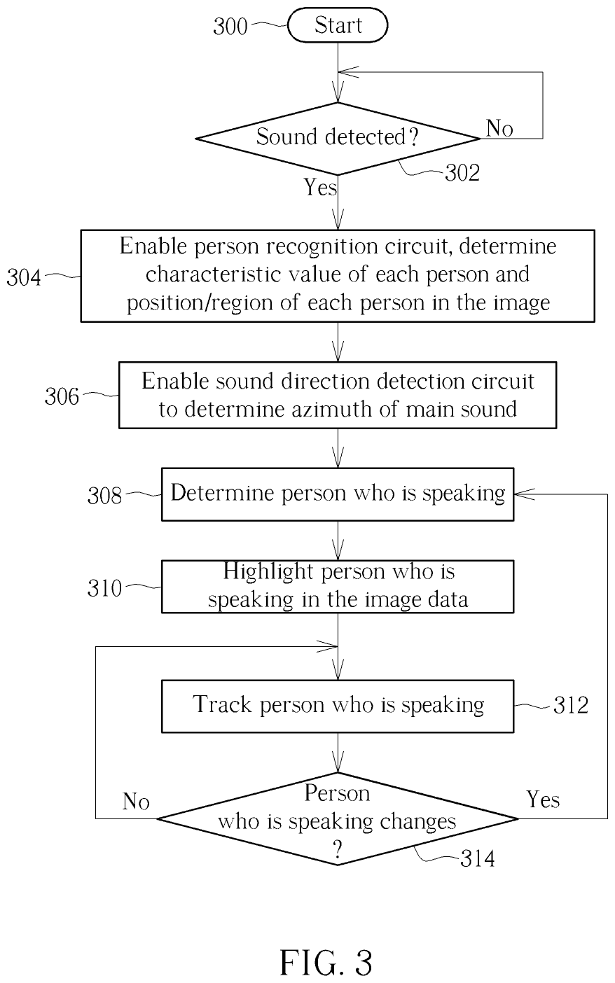

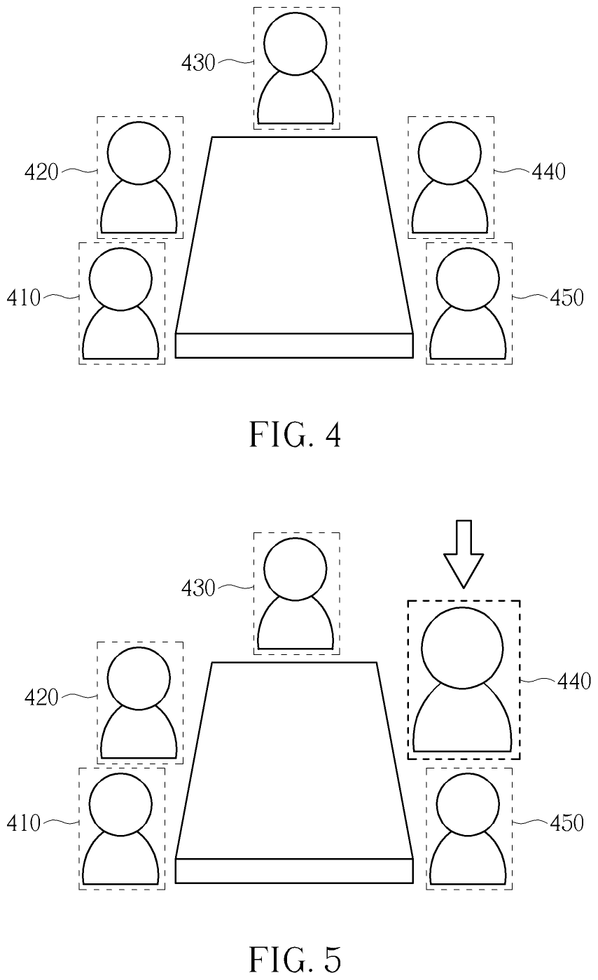

FIG. 3 is a flowchart of a video processing method according to one embodiment of the present invention. In Step 300, the flow starts, and the electronic device 110 is powered on and the connection with the electronic device 120 of the second conference room is completed. In step 302, the voice activity detection circuit 220 receives the sound signals from the microphones 204_1-204_N, and determines whether there is a voice component in these sound signals, if yes, the flow enters Step 304; if not, the flow stays in Step 302 to continue detecting if the received sound signals have voice components. In Step 304, after the processing circuit 240 knows that the voice activity detection circuit 220 detects that the sound signals have voice components, the processing circuit 240 enables the person recognition circuit 210, so that the person recognition circuit 210 starts to perform person recognition on the received image data to determine whether there is a person in the received image data, and to determine the characteristic value of each person and the position/region of each person in the image. Taking FIG. 4 as an example, the person recognition circuit 210 detects that there are five people in the image, so it can determine the regions 410-450 of each person in the frame, and determine the characteristic values of the contents in the regions 410-450 as the characteristic values of five people, respectively. In Step 306, the processing circuit 240 enables the sound direction detection circuit 230, and the sound direction detection circuit 230 starts to determine the direction and angle of the main sound relative to the electronic device 110 according to the time difference of the sound signals from the microphones 204_1-204_N. It is noted that Step 304 and Step 306 can be executed simultaneously, that is, the execution time of this embodiment is not limited to the sequence shown in FIG. 3.

In Step 308, the processing circuit 240 determines which person in the image (image frame) is speaking by using the regions where each person is located in the frame determined by the person recognition circuit 210 (for example, the regions 410-450 in FIG. 4) and the direction and angle of the main speaker relative to the electronic device 110 detected by the sound direction detection circuit 230. In Step 310, after determining the person who is speaking in the image, the processing circuit 240 processes the image data obtained from the image capturing device 202 to highlight the main speaker in the image data. Specifically, referring to FIG. 5, if the processing circuit 240 determines that the person in the region 440 is the main speaker, the processing circuit 240 can process the image data to enlarge the person in the region 440, or add label (s)/arrow (s) to the region 440, or any other image processing method to enhance the visual effect of the person in the region 440. After processing the image data to enhance the visual effect of the person in the region 440, the processing circuit 240 transmits the processed image data to a back-end circuit for other image processing, and then transmits the processed image data to the second electronic device 120 in the second conference room through the network, so that the participants in the second conference room can clearly know who is currently speaking in the first conference room.

It is noted that, the above-mentioned embodiments of enhancing the visual effects of the person in the region 440 do not necessarily need to visually enhance the entire region 440, but may only perform visual enhancement on apart of the region 440, which can also achieve the same effect. Taking FIG. 5 as an example, the region 440 includes head and body of the person, and the processing circuit 240 can only enlarge the head.

In Step 312, the processing circuit 240 continues to track the previously highlighted person, and continues to process the image data from the image capturing device 202 to highlight the person in the image data.

Specifically, the person recognition circuit 210 can continuously determine the region where each person is located in the frame and its characteristic value, and the processing circuit 240 can continue to highlight this person in the following frames according to the characteristic value of the previously highlighted person. Taking the region 440 in FIG. 5 as an example, the processing circuit 240 can track the region/person whose characteristic value is similar to those of the region 440 in the following received frames (for example, the characteristic value difference is within a range), so as to continuously highlight the person in the subsequent frames, even if the highlighted person does not speak for a short period of time in the subsequent frames, and the sound direction detection circuit 230 does not detect any sound in the direction of the person.

It should be noted that, since the person who is speaking may move, and may not continue to speak, Step 312 can avoid the continuous enabling and disabling the visual enhancement effect, which affects the feelings of the participants in the second conference room.

In Step 314, the processing circuit 240 determines if the person who is speaking is changed according to the region of each person in the frame determined by the person recognition circuit 210, the direction and angle of the main speaker relative to the electronic device 110 detected by the sound direction detection circuit 230, and whether someone is speaking detected by the voice activity detection circuit 220 (that is, the received sound signal has a voice component), if not, the flow goes back to Step 312 to track the person who is currently speaking; and if yes, the flow goes back to Step 308 to determine a new speaker who is speaking. Specifically, since the sound direction detection circuit 230 can only detect the direction of the sound, it is impossible to know whether the sound in the determined direction is a human voice. Therefore, by using the voice activity detection circuit 220, when the voice activity detection circuit 220 detects that there is a voice component in the current sound signal, if the sound direction detection circuit 230 detects the direction and angle of the main speaker relative to the electronic device 110 is changed to the position of another person, the processing circuit 240 can determine that the person who is speaking has changed. It is noted that, in order to prevent the processing circuit 240 from constantly changing the highlighted person in the image data, the execution of Step 314 will require detection for a long period of time before making a decision.

In another embodiment, in order to further confirm whether the person who is speaking has changed, the processing circuit 240 may additionally include a voiceprint recognition mechanism to assist the detection result of the sound direction detection circuit 230. Specifically, since each person's voice has unique voice characteristics, the voiceprint recognition mechanism in the processing circuit 240 can continuously capture sound clips to determine whether the voice characteristics of these sound clips belong to the same person, for the determination of the speaker. For example, if it is determined that the person who is speaking has changed according to the results of the person recognition circuit 210, the voice activity detection circuit 220 and the sound direction detection circuit 230, but the voiceprint recognition mechanism determines that the voice characteristics of the sound clips belongs to the same person, the processing circuit 240 can suspend determining whether the person who is speaking has changed, and then make a decision after detecting for a period of time.

In the previous embodiments, the sound direction detection circuit 230 is used as the sound detection circuit, however, the present invention is not limited thereto. In other embodiments, the sound direction detection circuit 230 of the above-mentioned embodiment can be replaced by a voiceprint recognition mechanism, and the person to be highlighted is only determined according to the voiceprint recognition result. In other words, the sound detection circuit of the present invention can obtain a plurality of sound signals from a plurality of microphones to determine a sound characteristic value of a main sound, and the sound characteristic value can be an azimuth angle of the main sound or is the sound characteristic value of the sound clips for the voiceprint recognition mechanism.

Briefly summarized, in the video processing method of the present invention, by detecting the person who is currently speaking and highlighting the person in the image data, the participants in the remote conference room can clearly know who is currently speaking, to effectively improve meeting efficiency.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A system on chip (SoC), comprising:
a person recognition circuit, configured to obtain image data from an image capturing device, and perform a person recognition operation on the image data to generate a recognition result;
a sound detection circuit, configured to receive a plurality of sound signals from a plurality of microphones, and determine a sound characteristic value of a main sound;
a processing circuit, coupled to the person recognition circuit and the sound detection circuit, configured to determine a specific region in the image data according to the recognition result and the sound characteristic value of the main sound, and process the image data to highlight the specific region.

2. The SoC of claim 1, further comprising:
a voice activity detection circuit, configured to determine whether at least part of the sound signals comprises a voice component according to the plurality of sound signals;
wherein the processing circuit determines whether to determine the specific region in the image data according to the recognition result and the sound characteristic value of the main sound according to whether the at least part of the sound signal comprises the voice component.

3. The SoC of claim 2, wherein only when the voice activity detection circuit indicates that the at least part of the sound signals comprises the voice component, the processing circuit will determine the specific region in the image data according to the recognition result and the sound characteristic value of the main sound, and process the image data to highlight the specific region.

4. The SoC of claim 1, wherein the recognition result comprises a plurality of regions, each region comprises a person; and the processing circuit refers to the sound characteristic value of the main sound to select one of the regions to serve as the specific region.

5. The SoC of claim 4, wherein the recognition result further comprises a plurality of characteristic values respectively corresponding to the plurality of regions, and the processing circuit tracks the characteristic value of the specific region to determine a position of the specific region in the subsequent image data, and processes the subsequent image data to highlight the specific region in the subsequent image data.

6. The SoC of claim 5, further comprising:
a voice activity detection circuit, configured to determine whether at least part of the sound signals comprises a voice component according to the plurality of sound signals;
wherein the processing circuit determine whether the person who is speaking is changed according to the plurality of characteristic values respectively corresponding to the plurality of regions determined by the person recognition circuit, the sound characteristic value of the main sound detected by the sound detection circuit, and whether the at least part of the sound signal comprises the voice component detected by the voice activity detection circuit, for determining whether to select another region from the plurality of regions to serve as the specific region.

7. The SoC of claim 1, wherein the processing circuit processes the image data to enlarge a person within the specific region.

8. The SoC of claim 1, wherein the sound detection circuit is a sound direction detection circuit, and the sound characteristic value of the main sound is an azimuth of the main sound.

9. A video processing method, comprising:
obtaining image data from an image capturing device, and performing a person recognition operation on the image data to generate a recognition result;
receiving a plurality of sound signals from a plurality of microphones, to determine a sound characteristic value of a main sound;
determining a specific region in the image data according to the recognition result and the sound characteristic value of the main sound; and
processing the image data to highlight the specific region.

10. The video processing method of claim 9, further comprising:
determining whether at least part of the sound signals comprises a voice component according to the plurality of sound signals;
determining whether to determine the specific region in the image data according to the recognition result and the sound characteristic value of the main sound according to whether the at least part of the sound signal comprises the voice component.

11. The video processing method of claim 10, wherein the step of determining whether to determine the specific region in the image data according to the recognition result and the sound characteristic value of the main sound according to whether the at least part of the sound signal comprises the voice component comprises:
only when the voice activity detection circuit indicates that the at least part of the sound signals comprises the voice component, determining the specific region in the image data according to the recognition result and the sound characteristic value of the main sound, and processing the image data to highlight the specific region.

12. The video processing method of claim 9, wherein the recognition result comprises a plurality of regions, each region comprises a person; and the processing circuit refers to the sound characteristic value of the main sound to select one of the regions to serve as the specific region.

13. The video processing method of claim 12, wherein the recognition result further comprises a plurality of characteristic values respectively corresponding to the plurality of regions, and the video processing method further comprises:
tracking the characteristic value of the specific region to determine a position of the specific region in the subsequent image data, and processing the subsequent image data to highlight the specific region in the subsequent image data.

14. The video processing method of claim 13, further comprising:
determining whether at least part of the sound signals comprises a voice component according to the plurality of sound signals;
determining whether the person who is speaking is changed according to the plurality of characteristic values respectively corresponding to the plurality of regions, the sound characteristic value of the main sound, and whether the at least part of the sound signal comprises the voice component, for determining whether to select another region from the plurality of regions to serve as the specific region.

15. The video processing method of claim 9, wherein the step of processing the image data to highlight the specific region comprises:
processing the image data to enlarge a person within the specific region.

16. The video processing method of claim 9, wherein the sound characteristic value of the main sound is an azimuth of the main sound.
